(19) United States
(12) Patent Application Publication
(10) Pub. No.: US 2014/0288898 A1
(43) Pub. Date: Sep. 25, 2014

(54) DEVICE SIMULATION METHOD AND DEVICE SIMULATION SYSTEM FOR TUNNEL FET, AND COMPACT MODEL DESIGN METHOD AND COMPACT MODEL FOR TUNNEL FET

(71) Applicant: National Institute of Advanced Industrial Science and Technology, Tokyo (JP)

(72) Inventor: Koichi Fukuda, Tsukuba-shi (JP)

(21) Appl. No.: 14/036,605

(22) Filed: Sep. 25, 2013

(30) Foreign Application Priority Data
Mar. 25, 2013 (JP) 2013-062366

(51) Int. Cl. G06F 17/50

(52) U.S. Cl. CPC G06F 17/5009
USPC 703/2

(57) ABSTRACT

A tunnel path of the tunnel FET at a source-gate overlap portion is divided into a vertical path vertical to the source-gate overlap portion and a horizontal path extending to a drain in a horizontal direction along a channel interface. A tunnel distance computation section obtains a tunnel distance for each position of a nonlocal electric field band-to-band tunnel, using first and second bends of the mid-gap potential, which are previously stored approximate functions of the mid-gap potential on the vertical and horizontal paths, respectively. A carrier generation rate computation section computes a carrier generation rate due to band-to-band tunneling, based on the tunnel distance at each position of the nonlocal electric field band-to-band tunnel and a band gap.

### FIELD OF THE INVENTION

The present invention relates to device simulation method and device simulation system for a tunnel FET, and compact model design method and compact model for the tunnel FET.

### BACKGROUND OF THE INVENTION

A tunnel-FET (TFET) has drawn attraction as a key device for implementing a circuit with lower power consumption than with a CMOS. JP2012-182368A (Patent Document 1) discloses a configuration example of the tunnel-FET. JP2009-302419A (Patent Document 2) discloses simulation method and apparatus for a MOSFET.

### SUMMARY OF THE INVENTION

In device design of a tunnel-FET, a design tool that takes into account of the structure of the tunnel-FET and the influence of material parameters of the tunnel-FET is needed. In circuit design, however, it is a challenge to assemble a circuit using the tunnel-FET that performs an operation completely different from that of a conventional device. A compact model is therefore needed in order to study the circuit design.

An object of the present invention is to provide a device simulation method and a device simulation system that are operable to simulate a rate of carrier generation due to band-to-band tunneling in a tunnel-FET.

Another object of the present invention is to provide a tunnel-FET modeling system in which, by obtaining a rate of carrier generation, a tunnel-FET is modeled.

Further another object of the present invention is to provide a modeling method for a compact model of nonlocal electric field band-to-band tunneling of a tunnel-FET.

Still another object of the present invention is to provide a compact model of nonlocal electric field band-to-band tunneling of a tunnel FET.

The present invention is based on confirmation by the inventors of the present invention that, when a physical model based on a model of nonlocal band-to-band tunneling has been constructed in a device simulator, electrical characteristics at practical level have been obtained.

A first aspect of the present invention provides a device simulation method of simulating a rate of carrier generation due to band-to-band tunneling in a tunnel-FET. By executing a step of tracing, a step of defining a nonlocal electric field, and a step of computing the rate of carrier generation, the rate of carrier generation due to the band-to-band tunneling in the tunnel-FET is simulated. In the step of tracing, band energy of the tunnel-FET is traced to obtain a tunnel distance and a band gap E_{G}. In the step of defining the nonlocal electric field, a nonlocal electric field Enonl (=E_{G}/L) is defined using the band gap E_{G} and the tunnel distance L obtained by the step of tracing. Then, in the step of computing the rate of carrier generation, a rate G of carrier generation due to band-to-band tunneling is computed, based on the following equation:

G=A·Enonl^{p}·exp(−B/Enonl)

(where A, B, and p are parameters of Kane's formula to be determined by a semiconductor material).

In the present invention, the band energy is traced in a device simulator in order to accurately estimate the tunnel distance. The nonlocal electric field is defined, using the tunnel distance obtained by the tracing and the band gap supplied from the device simulator. Then, the nonlocal electric field is substituted into the above-mentioned equation to compute the rate G of carrier generation due to the band-to-band tunneling. The tracing is actually performed in a two-dimensional space when cross-sectional simulation is performed. When three-dimensional simulation is performed, the tracing is actually performed in a three-dimensional space. This arrangement makes it possible to compute the carrier generation rate with a high accuracy even if the tunnel path is steeply bent, as in the tunnel FET.

In the step of computing the rate of carrier generation, the rate G of carrier generation due to the band-to-band tunneling may be computed based on the tunnel distance L and the band gap E_{G}, according to the following equation:

G=A·Enonl^{p}·exp[−L/(E_{G}/B)]

(where A, B, and p are parameters of Kane's formula to be determined by a semiconductor material).

As the band energy, energy of one of a conduction band E_{C} and a valance band E_{V} may be employed.

In the step of tracing, the tunnel distance is determined by a step of assuming meshes, a first selection step, a second selection step, a repetition step, and a step of determining the tunnel distance. In the step of assuming the meshes, an analysis target structure is divided into a plurality of meshes including a plurality of mesh points. In the first selection step, one of the plurality of mesh points of the plurality of meshes is set as a start point and then another mesh point with a largest energy gradient is selected from among the mesh points around the start point. Then, in the second selection step, the selected mesh point is set as a start point and then, from among the mesh points around the selected mesh point as the start point, another mesh point with a largest energy gradient is selected. Further, in the repetition step, the second selection step is repeated until the mesh point with energy that is the same as energy of the other of the conduction band and the valence band is obtained as an end point. Finally, in the step of determining the tunnel distance, a distance obtained by adding up distances between two adjacent ones of the mesh point of the start point, the selected mesh points, and the mesh point of the end point is determined as the tunnel distance. When the added up distance is used as the tunnel distance, the simulation may be performed with a high accuracy even if the tunnel path is steeply bent, as in the tunnel FET.

In the step of determining the tunnel distance, a distance between the mesh point of the start point and the mesh point of the end point may also be determined as the tunnel distance. With such arrangement, computation of the tunnel distance is simplified, though the accuracy of the simulation is reduced.

In the step of tracing, an energy difference between the conduction band and the valence band at the start point may be determined as the band gap E_{G}.

In a tunnel-FET modeling method of the present invention, the tunnel-FET as a whole may be modeled by obtaining the rate of carrier generation for each of the plurality of mesh points in the plurality of meshes, using the device simulation method.

The present invention may also be grasped as a device simulation system operable to simulate a rate of carrier generation due to band-to-band tunneling in a tunnel-FET. The device simulation system of the present invention comprises a tracing section, a nonlocal electric field definition section, and a carrier generation rate computation section. The tracing section is operable to trace band energy of the tunnel-FET to obtain a tunnel distance. The nonlocal electric field definition section is operable to define a nonlocal electric field Enonl (=E_{G}/L) using the tunnel distance L obtained by the tracing section and the band gap E_{G} supplied from the device simulator; The carrier generation rate computation section is operable to compute a rate of carrier generation due to band-to-band tunneling, based on the following equation:

G=A·Enonl^{p}·exp(−B/Enonl)

(where A, B, and p are parameters of Kane's formula to be determined by a semiconductor material).

Without using the nonlocal electric field definition section, the carrier generation rate computing section may compute the rate of carrier generation due to the band-to-band tunneling, based the tunnel distance L and the band gap E_{G}, according to the following equation:

G=A·Enonl^{p}·exp[−L/(E_{G}/B)]

(where A, B, and p are parameters of Kane's formula to be determined by a semiconductor material).

The tracing section may be configured to include: a mesh assumption section, a first selection section, a second selection section, a repetition section, and a tunnel distance determination section. The mesh assumption section is operable to assume a plurality of meshes including a plurality of mesh points and divide an analysis target structure into the plurality of meshes including the plurality of mesh points. The first selection section is operable to set one of the plurality of mesh points of the plurality of meshes as a start point and then to perform a first selection step of selecting, from among the mesh points around the start point, the mesh point with a largest energy gradient. The second selection section is operable to set the selected mesh point as a start point and then to perform a second selection step of selecting, from among the mesh points around the selected mesh point as the start point, the mesh point with a largest energy gradient. The repetition section is operable to repeat the second selection step until the mesh point with energy that is the same as energy of the other of the conduction band and the valence band is obtained as an end point. Preferably, the tunnel distance determination section is configured to determine, as the tunnel distance, a distance obtained by adding up distances between two adjacent ones of the mesh point of the start point, the selected mesh points, and the mesh point of the end point. The tunnel distance determination section of the tracing section may be configured to determine, as the tunnel distance, a distance between the mesh point of the start point and the mesh point of the end point.

In a tunnel-FET modeling system, the tunnel-FET is modeled by obtaining the carrier generation rate for each of the plurality of mesh points in the plurality of meshes, using the above-mentioned device simulation system.

In a circuit using the tunnel-FET, there is a problem in terms of the circuit that the tunnel FET exhibits asymmetric characteristics with respect to a source-drain voltage, or the like. In order to implement a circuit that takes advantage of the tunnel-FET, it is necessary for a circuit design tool to be able to urgently deal with the tunnel FET. Then, the need for developing a compact model of the tunnel-FET to be used for a circuit simulator has arisen. A second invention of the present application provides the compact model of nonlocal electric field band-to-band tunneling of a tunnel-FET and a design method of the compact model, in order to respond to such a need. As adopted in the above-mentioned device simulation system and in the above-mentioned device simulation method, steep band transitions are adopted in the compact model, and nonlocality of a tunnel path is taken into consideration. In order to implement this compact model of nonlocal electric field band-to-band tunneling using simple computation, the following approximation is introduced into the compact model of the present invention. That is, the approximation is introduced where the nonlocal tunnel path is divided into two paths that are a vertical path vertical to a source-gate overlap portion and a horizontal path extending from the source-gate overlap portion to a drain in a horizontal direction along a channel interface.

Then, in the modeling method for the compact model, the compact model of nonlocal electric field band-to-band tunneling of the tunnel FET is designed so that a current value obtained in first to fifth steps is equal to the value of an output current with respect to a source-to-gate voltage. In the first step, the tunnel path of the tunnel-FET at the source-gate overlap portion is divided into the two paths that are the vertical path vertical to the source-gate overlap portion and the horizontal path extending to the drain in the horizontal direction along the channel interface, and a first bend of a mid-gap potential (corresponding to an electrostatic potential) on the vertical path with respect to the source-gate voltage is computed as an approximation function of the mid-gap potential based on a theoretical equation for a MOS capacitor. In the second step, a second bend of the mid-gap potential on the horizontal path with respect to the source-gate voltage is computed as an approximation function of the mid-gap potential using capacitance. In the third step, a tunnel distance L is obtained for each position of a nonlocal electric field band-to-band tunnel, using the first and second bends of the mid gap potential, and a band gap E_{G} is obtained. In the fourth step, a rate G of carrier generation due to band-to-band tunneling at each position of the nonlocal electric field band-to-band tunnel is computed, based on the tunnel distance L and the band gap E_{G}. Then, in the fifth step, the current value is obtained by numerically integrating the rate of carrier generation at each position of the nonlocal electric field band-to-band tunnel. According to the present invention, a compact model may be designed whereby vertical and horizontal band energy distributions may be computed using an electrode voltage and then a distance necessary for tunneling may be obtained.

In the fourth step, based on the tunnel distance L and the band gap E_{G}, the rate of carrier generation due to the band-to-band tunneling is computed by the following equation:

G=A·Enonl^{p}·exp[−L/(E_{G}/B)]

(where A, B, and p are parameters of Kane's formula to be determined by a semiconductor material).

The compact model of nonlocal electric field band-to-band tunneling of the tunnel-FET according to the present invention comprises first and second storage sections and first to third computation sections. The first storage section is operable to divide the tunnel path of the tunnel-FET at the source-gate overlap portion into the two paths that are the vertical path vertical to the source-gate overlap portion and the horizontal path extending to the drain in the horizontal direction along the channel interface, and to store the first bend of a mid-gap potential on the vertical path with respect to the source-gate voltage as the approximation function of the mid-gap potential based on the theoretical equation for a MOS capacitor. The second storage section is operable to store the second bend of the mid-gap potential on the horizontal path with respect to the source-gate voltage as the approximation function of the mid-gap potential using capacitance. The first computation section is operable to obtain the tunnel distance L for each position of the nonlocal electric field band-to-band tunnel, using the first and second bends of the mid-gap potential. The second computation section is operable to compute the rate G of carrier generation due to the band-to-band tunneling at each position of the nonlocal electric field band-to-band tunnel, based on the tunnel distance L and the band gap E_{G}. The third computation section is operable to obtain the current value by numerically integrating the carrier generation rate at each position of the nonlocal electric field band-to-band tunnel. Since this compact model uses the functions, this compact model has an advantage that computation may be performed at high speed.

Another compact model of nonlocal band-to-band tunneling of a tunnel-FET according to the present invention comprises a profile storage section and first to third computation sections. The profile storage section is operable to divide a tunnel path of the tunnel-FET at a source-gate overlap portion into two paths that are a vertical path vertical to the source-gate overlap portion and a horizontal path extending to a drain in a horizontal direction along a channel interface, to store a vertical energy distribution of a mid-gap potential on the vertical path with respect to a source-gate voltage as an approximation function of the mid-gap potential based on a theoretical equation for a MOS capacitor, and to store a fitting function of a horizontal energy distribution of the mid-gap potential on the horizontal path with respect to the source-gate voltage as a function fit to a numerical simulation result, thereby storing a profile of the mid-gap potential of a nonlocal electric field band-to-band tunnel. The first computation section is operable to obtain a tunnel distance L for each position of the nonlocal electric field band-to-band tunnel, using the profile. The second computation section is operable to compute a rate G of carrier generation due to band-to-band tunneling based on the tunnel distance L and a band gap E_{G}. Then, the third computation section is operable to obtain a current value by numerically integrating the rate of carrier generation at each position of the nonlocal electric field band-to-band tunnel. According to the compact model of the present invention, by using the profile storage section, the profile of the mid-gap potential may be more accurately obtained. Further, the profile of the mid-gap potential is fit to the functions. Thus, computation may be performed at high speed.

A further another compact model of nonlocal band-to-band tunneling of a tunnel-FET according to the present invention comprises a profile storage section and first to third computation sections. The mid-gap potential profile storage section is operable to divide a tunnel path of the tunnel-FET at a source-gate overlap portion into two paths that are a vertical path vertical to the source-gate overlap portion and a horizontal path extending to a drain in a horizontal direction along a channel interface, to store a mid-gap potential on the vertical path with respect to a source-gate voltage calculated by an approximation of the mid-gap potential based on a theoretical equation for a MOS capacitor, and to store the mid-gap potential on the horizontal path with respect to the source-gate voltage determined based on a numerical simulation result, thereby storing a profile of the mid-gap potential of a nonlocal electric field band-to-band tunnel. The first computation section is operable to obtain a tunnel distance L for each position of the nonlocal electric field band-to-band tunnel, using the profile. The second computation section is operable to compute a rate G of carrier generation due to band-to-band tunneling based on the tunnel distance L and a band gap E_{G}. Then, the third computation section is operable to obtain a current value by numerically integrating the rate of carrier generation at each position of the tunnel. According to the compact model of the present invention, by using the profile storage section, the profile of the mid-gap potential may be most accurately obtained.

Based on the tunnel distance L and the band gap E_{G}, the second computation section may compute the rate of carrier generation due to the band-to-band tunneling by the following equation:

G=A·Enonl^{p}·exp[−L/(E_{G}/B)]

(where A, B, and p are parameters of Kane's formula to be determined by a semiconductor material, and Enol^{p} is a nonlocal electric field).

### BRIEF DESCRIPTION OF THE DRAWINGS

These and other objects and many of the attendant advantages of the present invention will be readily appreciated as the same becomes better understood by reference to the following detailed description when considered in connection with the accompanying drawings.

FIG. 1 includes diagrams used for explaining the structure and operation principle of a tunnel-FET.

FIGS. 2A and 2B are diagrams showing difference between a PN junction (on the left of the drawings) and a tunnel path of the tunnel-FET (on the right of the drawings).

FIG. 3 is a diagram used for explaining definition of a nonlocal electric field using a tunnel distance.

FIG. 4 is a block diagram showing a configuration of an embodiment when a device simulation system of the present invention is implemented by a computer.

FIG. 5 is a flowchart showing an algorithm of computer software to be installed into the computer when the embodiment shown in FIG. 4 is implemented by the computer.

FIG. 6 is a flowchart showing details of step ST2 in the flowchart of FIG. 5.

FIG. 7 is a diagram used for explaining tracing.

FIG. 8 is a diagram used for explaining the tracing.

FIG. 9 is a flowchart of the software when a conduction band (Ec) is traced.

FIG. 10 is a flowchart of the software when a valence band (Ev) is traced.

FIG. 11 is a graph showing comparison among results obtained by device simulations using local and nonlocal electric field models and actual measurement values with marks.

FIG. 12A shows a rate of carrier generation at a gate-to-source voltage Vgs of −1V computed by the local model.

FIG. 12B shows a rate of carrier generation at the gate-to-source voltage Vgs of −1V computed by the nonlocal model.

FIG. 13 is a diagram used for explaining computation options.

FIG. 14 is a graph showing comparisons of Id-Vg characteristics obtained when using different computation options.

FIG. 15 is a diagram used for explaining the volume effect of a tunnel path.

FIG. 16 is a graph showing comparisons of Id-Vg characteristics obtained by tracing in forward and backward directions in consideration of the volume effect and without consideration of the volume effect.

FIG. 17 is a diagram showing division of a nonlocal tunnel path at a source-gate overlap portion into a vertical path vertical to the source-gate overlap portion and a horizontal path extending from the source-gate overlap portion to a drain in a horizontal direction along a channel interface.

FIG. 18 is a block diagram showing a configuration of an embodiment in which a compact model and a modeling method for the compact model according to the present invention are implemented by a computer.

FIG. 19 is a flowchart showing an algorithm of software to be installed into the computer.

FIG. 20 is a diagram for explaining a mid-gap potential.

FIG. 21 is a graph showing comparisons of potentials (indicated by lines) computed based on a capacitance ratio between a source and a gate and potentials (with marks) computed by a device simulator.

FIG. 22 is a graph showing Id-Vg characteristics of an N-type TFET computed by a device simulation system using a nonlocal model.

FIG. 23 is a graph showing Id-Vg characteristics of the N-type TFET computed by a compact model.

FIG. 24 is a diagram showing comparisons between results obtained by the compact model and actual measurement values.

FIG. 25 is a graph showing characteristics of an inverter using tunnel-FETs computed by the compact model.

FIG. 26 is a block diagram showing a configuration of a different embodiment of the compact model of the present invention.

FIG. 27 is a flowchart of software to be used when the configuration shown in FIG. 26 is implemented by a computer.

FIG. 28 is a flowchart showing an algorithm of software to be used in an embodiment where band profiles to be stored in a profile storage section are obtained by another method.

FIG. 29 is a diagram for explaining a concept when a horizontal band energy distribution (potential) is used by numerical computation.

FIG. 30 is a flowchart showing an algorithm of software to be used in an embodiment where band profiles to be stored in a profile storage section are obtained by another method.

### DETAILED DESCRIPTION OF PREFERRED EMBODIMENTS

### Device Simulation System

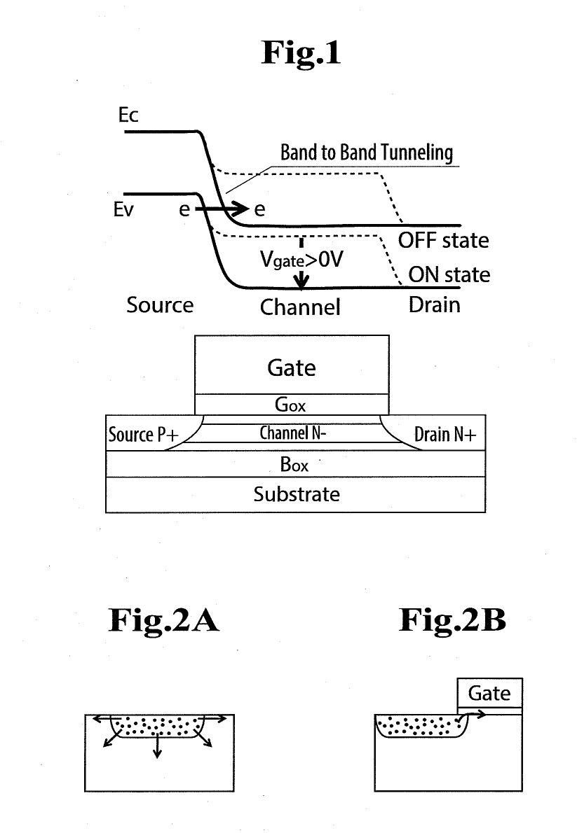

First, an embodiment of a device simulation system and an embodiment of a device simulation method according to the present invention will be described with reference to drawings. A tunnel-FET (TFET) utilizes a band-to-band tunneling phenomenon that occurs in a source-gate overlap region of the tunnel-FET, for switching on/off of the tunnel-FET. FIG. 1 is a schematic diagram of an N-type TFET. Different from a common CMOS, the tunnel FET has in its source a P+ layer. As shown in an energy band diagram, when the band position of the channel of the N-type TFET is lowered by a gate voltage, a valence band (Ev) and a conduction band (Ec) become closer at an end of the source. Band-to-band tunneling therefore occurs. According to the tunnel-FET, a quick switching characteristic can be obtained due to this principle, compared with a conventional MOS FET. As result, an LSI with the tunnel-FET can be obtained, having a lower power consumption than the CMOS LSI.

A conventional device simulation system uses a local model that expresses a rate of carrier generation due to band-to-band tunneling as a function of a local electric field. The conventional device simulation system was developed in order to obtain a leak current at a PN junction. Accordingly, even if it is regarded that an electric field to be applied to the PN junction is substantially in the form of a straight line and the inverse of a tunnel distance is set to the local electric field, no problem will arise. Thus, the conventional device simulation system uses the local model. However, different from the electric field at the P-N junction shown in FIG. 2A, a vertical large electric field is applied at the source-gate overlap region, and a strong electric field is also generated in a channel region in the tunnel FET, as shown in FIG. 2B. Electric field strength of the electric field greatly varies in the range of a tunnel path.

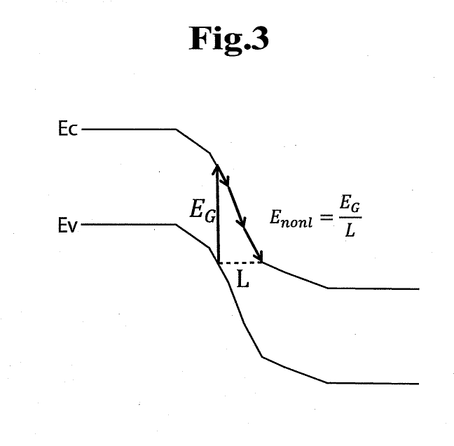

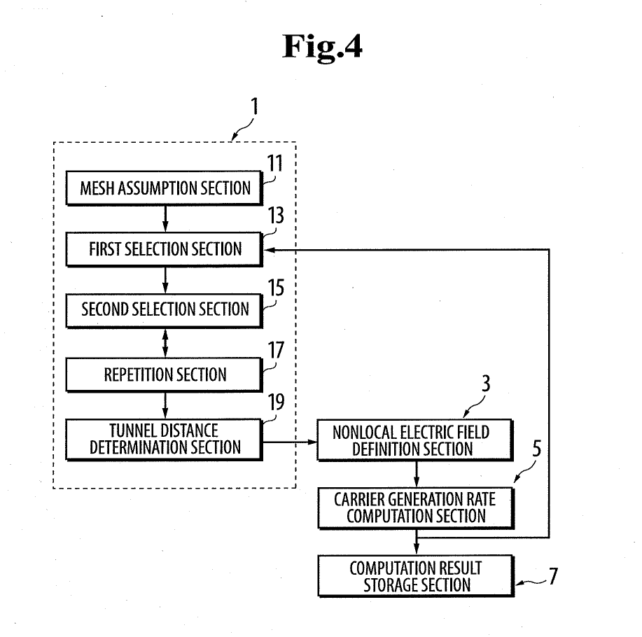

Then, in the device simulation system of the present invention, band energy (of the conduction band Ec or the valence band Ev) is traced in order to accurately estimate a tunnel distance. A nonlocal electric field Enonl is then defined, using an obtained tunnel distance L and a band gap E_{G} (as shown in FIG. 3). This tracing approach is described in detail in Known Document 1 (K. Fukuda, T. Mori, W. Mizubayashi, Y. Morita, A. Tanabe, M. Masahara, T. Yasuda, S. Migita, and H. Ota, “TCAD-based Modeling of Tunnel TETs,” Int. Symp. “Develop. Core Tech. Green Nanoelectronics”, March 2012). This tracing approach will be briefly described herein as well. In the present invention, this nonlocal electric field Enonl is substituted into usual Kane's formula to compute a rate G of carrier generation due to band-to-band tunneling. The tracing is actually performed in a two-dimensional space when cross-sectional simulation is performed. When three-dimensional simulation is performed, the tracing is actually performed in a three-dimensional space. This arrangement makes it possible to compute the rate of carrier generation even if the tunnel path is steeply bent, as in the tunnel FET.

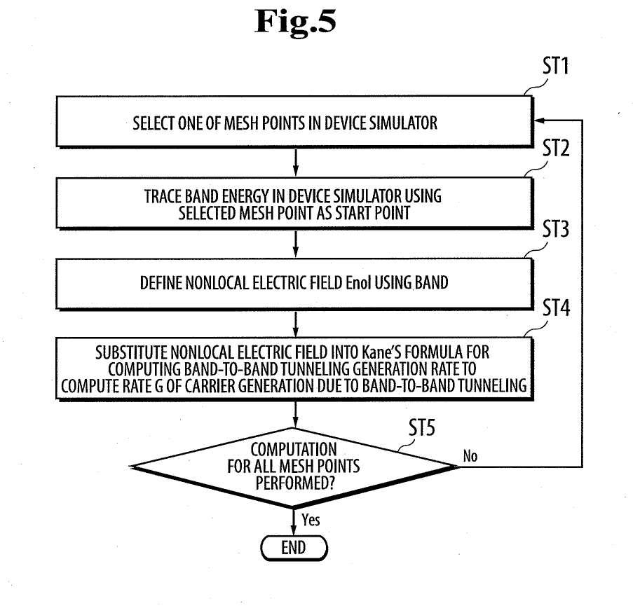

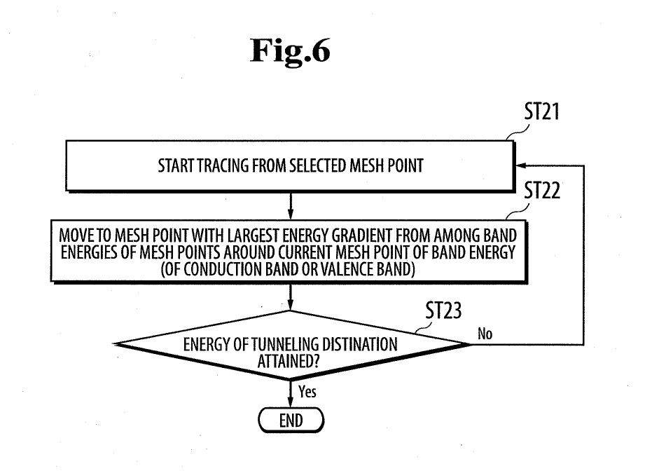

FIG. 4 is a block diagram showing a configuration of the embodiment when the device simulation system of the present invention is implemented by a computer. FIG. 5 is a flowchart showing an algorithm of computer software to be installed into the computer when the embodiment shown in FIG. 4 is implemented by the computer. FIG. 6 is a flowchart showing details of step ST2 in the flowchart in FIG. 5. In the device simulation system of the present invention, a tracing section 1, a nonlocal electric field definition section 3, and a carrier generation rate computation section 5 are constructed in the computer by the software to simulate the rate of carrier generation due to band-to-band tunneling in the tunnel FET. Simulation results about all mesh points are stored in a computation result storage section 7.

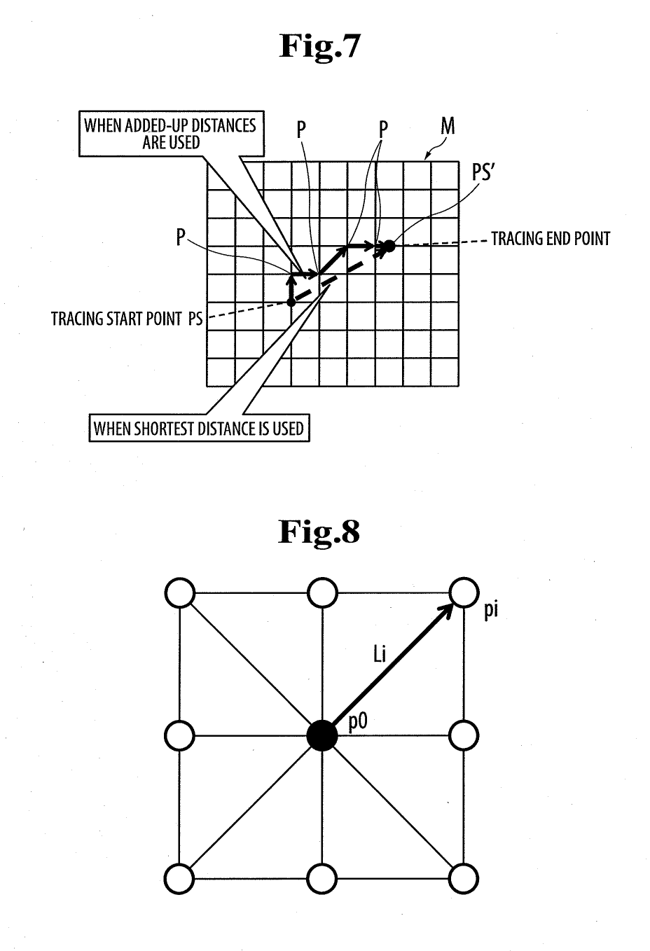

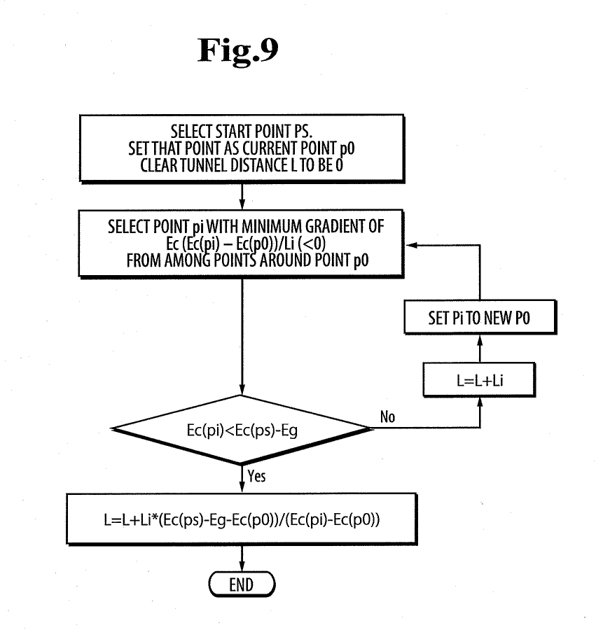

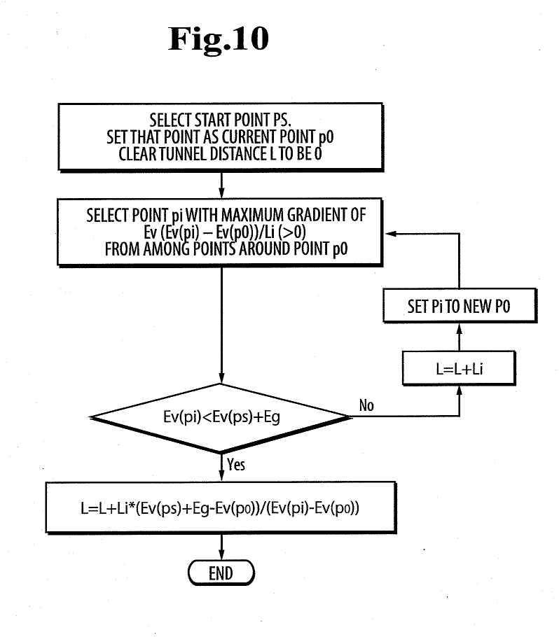

The tracing section 1 obtains the tunnel distance L by tracing the band energy (of one of the conduction band Ec and the valence band Ev) of the tunnel FET, as shown in FIG. 3. The tracing section 1 includes a mesh assumption section 11, a first selection section 13, a second selection section 15, a repetition section 17, and a tunnel distance determination section 19. As shown in FIG. 7, the mesh assumption section 11 divides an analysis target structure of the tunnel FET into a plurality of meshes M including a plurality of mesh points (mesh intersection points) PS. As a first selection step, the first selection section 13 sets one of the plurality of mesh points PS of the plurality of meshes M as a start point p0 and then selects, from among the mesh points around the start point, a mesh point pi with a largest energy gradient (in steps ST1 and ST2 in FIG. 5 and steps ST21 and ST22 in FIG. 6). Each mesh point has both of energy values of Ec (the conduction band) and Ev (the valence band) at the position of the mesh point. The distance between the positions of the mesh points p0 and pi is indicated by Li in FIG. 8. As shown in FIG. 8, as a second selection step, the second selection section 15 also sets the selected mesh point PS as a start point p0 and then selects, from among the mesh points around the selected mesh point as the start point, a mesh point pi with a largest energy gradient. The distance Li in FIG. 8 is a part of the tunnel distance. The repetition section 17 repeats the second selection step until the selected mesh point with energy that is the same as energy of the other of the conduction band and the valence band is obtained as an end point (in steps ST21 to ST23 in FIG. 6). Then, the tunnel distance determination section 19 is configured to determine as the tunnel distance L, a distance obtained by adding up distances between two adjacent ones of the mesh point PS of the start point, the selected mesh points P, and the mesh point PS′ of the end point. FIG. 9 is an example of a flowchart of the software when the conduction band (Ec) is traced. FIG. 10 is an example of a flowchart of the software when the valence band (Ev) is traced.

As shown by broken lines in FIG. 7, the tunnel distance determination section 19 of the tracing section 1 may be configured to determine the distance between the mesh point of the start point and the mesh point of the end point as the tunnel distance.

The nonlocal electric field definition section 3 defines the nonlocal electric field Enonl (=E_{G}/L) using the tunnel distance L obtained by the tracing section 1 and the band gap E_{G} supplied from a device simulator (as shown in FIG. 3 and step ST3 in FIG. 5). The carrier generation rate computation section 5 computes the rate G of carrier generation due to the band-to-band tunneling, based on the following Kane's formula (in step ST4).

G=A·Enonl^{p}·exp(−B/Enonl)

where A, B, and p are parameters of Kane's formula to be determined by a semiconductor material. Equation (1) in Known Document 2 (Kuo-Hsing Kao; Verhulst, A. S.; Vandenberghe, W. G.; Soree, B.; Groeseneken, G.; De Meyer, K., “Direct and Indirect Band-to-Band Tunneling in Germanium-Based TFETS”, Electron Devices, IEEE Transactions on, vol. 59, no. 2, pp. 292,301, February 2012) corresponds to the above-mentioned Kane's formula. Equations (15) and (16) disclosed in Known Document 3 (IEEETED1983_Semiconductor_Device_Simulation (Fichtner). pdf Fichtner, W.; Rose, D. J.; Bank, R. E., “Semiconductor device simulation,” Electron Devices, IEEE Transactions on, vol. 30, no. 9, pp. 1018, 1030, September 1983) are equations of continuity of electron holes. These equations include a term showing the rate G of carrier generation used for the device simulator.

In a tunnel-FET modeling system in this embodiment, the tunnel-FET is modeled by obtaining the rate G of carrier generation for each of the plurality of mesh points in the plurality of meshes, using the device simulation system (in step ST5 in FIG. 5).

The carrier generation rate computation section 5 may obtain the rate G of carrier generation due to the band-to-band tunneling, based on the nonlocal electric field Enonl, the tunnel distance L, and the band gap E_{G}, according to the following equation:

G=A·Enonl^{p}·exp[−L/(E_{G}/B)]

where A, B, and pare parameters of Kane's formula to be determined by the semiconductor material.

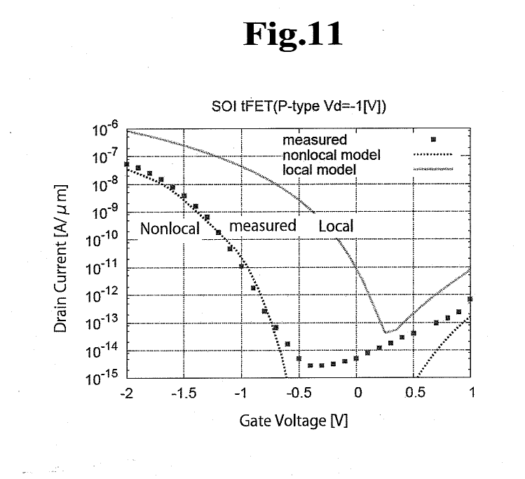

A result of modeling the Id-Vg characteristic of a P-type TFET by the above-mentioned modeling system in the embodiment using the nonlocal electric field is represented by a curve A in FIG. 11, while a result of modeling the Id-Vg characteristic of the P-type TFET using a local electric field is represented by a curve B in FIG. 11. Then, the results of modeling were compared with actual measurement values of the Id-Vg characteristic of the P-type TFET (disclosed in Known Document 4: T. Mori, K. Fukuda, A. Tanabe, T. Maeda, W. Mizubayashi, S. O'uchi, Y. Liu, M. Masahara, T. Yasuda, and H. Ota, “Impacts of EOT scaling on SOI Tunnel FETs and Demonstration of 33 mV/decade Subthreshold Slope,” Int. Symp. “Develop. Core Tech. Green Nanoelecronics”, March 2012. And in Known Document 5: S. Migita, and H. Ota, “Fabrication of Silicon Tunnel-FETs Using Epitaxial NiSi2 Schottky Source Junctions and Dopant Segregation Technique,” Int. Symp. “Develop. Core Tech. Green Nanoelectronics”, March 2012). As seen from FIG. 11, the values of the Ig-Vg characteristic modeled using the local model (represented by the curve B) greatly deviate from the actual measurement values of the Ig-Vg characteristic. On contrast therewith, the Id-Vg characteristic modeled using the nonlocal model (represented by the curve A) can predict the actual Id-Vg characteristic with a sufficient accuracy. Since the P-type TFET is used, this Id-Vg characteristic is obtained by applying a negative gate voltage. Current obtained by applying a positive gate voltage is Gate Induced Drain Leakage (GIDL) at the end of the drain. The modeling system in this embodiment can predict the GIDL as well.

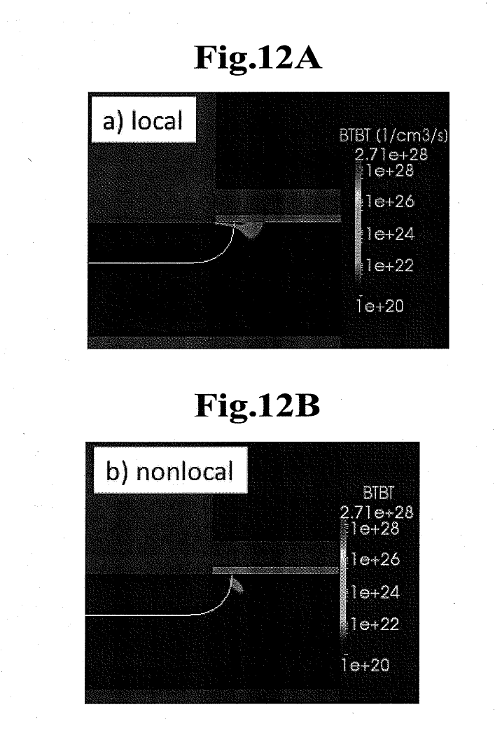

Next, in order to understand a difference between the modeling system using the nonlocal model and the modeling system using the local model, carrier generation rates computed by the nonlocal model and the local model at a gate-to-source voltage Vgs of −1V were compared. Referring to FIG. 12A showing the carrier generation rate obtained by the modeling system using the local model, a strong electric field occurs at the upper end of the source. Though the electric field is strong at the upper end of the source, tunneling does not actually occur at this location because there is no distance between the valence band and the conduction band corresponding to a band gap. A large error may occur at the MOS interface of the local model of band-to-band tunneling, as mentioned above. On contrast therewith, referring to FIG. 12B showing the carrier generation rate obtained by the modeling system in this embodiment using the nonlocal model, tunneling occurs only at a location where there is a sufficient energy difference corresponding to a band gap. As mentioned above, the tunnel-FET modeled by the modeling system in this embodiment using the nonlocal model captures an important aspect of band-to-band tunneling. A part of the modeling system that has employed the nonlocal model in this embodiment may be incorporated into the three-dimensional TCAD system HyENEXSS (registered trade mark) (ver5.5, Selete, 2011), and may be used for a multi-dimensional general-purpose system.

When the modeling system in this embodiment is incorporated into the device simulator, the following computation options can be selected:

(a) using, as the tunnel distance, a distance along the tracing, or a straight line distance connecting start and end points of the tracing, after the tunnel path could been obtained by tracing.

(b) setting the position of carrier generation due to the tunneling to the start point of the tracing after the tunneling, or generating holes and electrons separately at the start point of the tracing and the end point of the tracing.

(c) reversing the direction of the tracing.

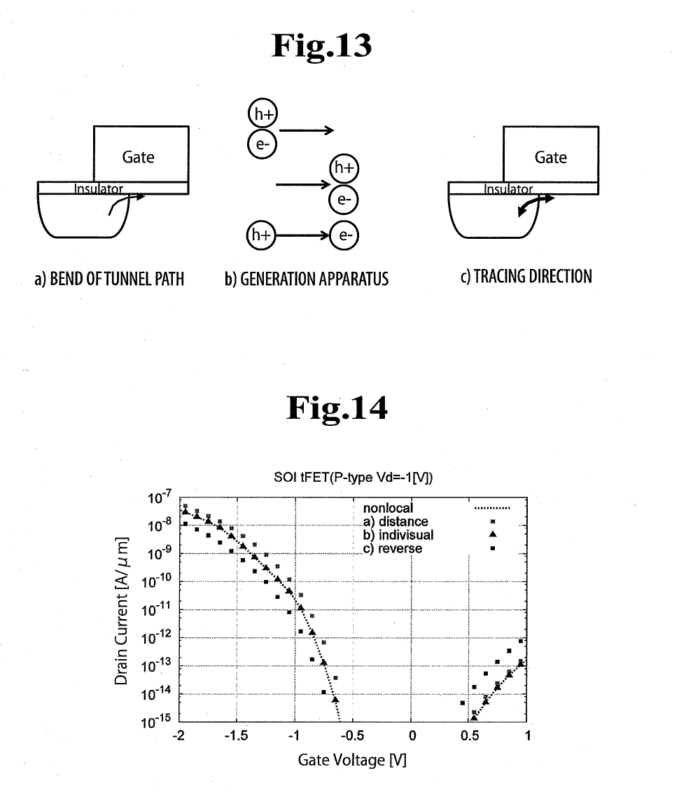

Concepts of the above-mentioned computation options are shown in FIG. 13.

Results obtained by actually incorporating these options into the device simulator and comparing Id-Vg characteristics of the P-type TFET computed using these options with the Id-Vg characteristic represented by reference curves indicated by broken lines are shown in FIG. 14. When the shortest distance was chosen in option (a), an increase in drain current was observed in each of the cases where the gate voltage was negative and where the gate positive was positive (as shown in curves marked with ▪). When the holes and electrons were generated separately in option (b), curves (marked with ▴) representing the Id-Vg characteristic of the P-type TFET computed with this option showed the same results as those represented by the reference curves. When the tracing direction was reversed in option (c), a decrease in the drain current was observed when the gate voltage was negative, and a slight increase in the drain current was observed when the gate voltage was positive.

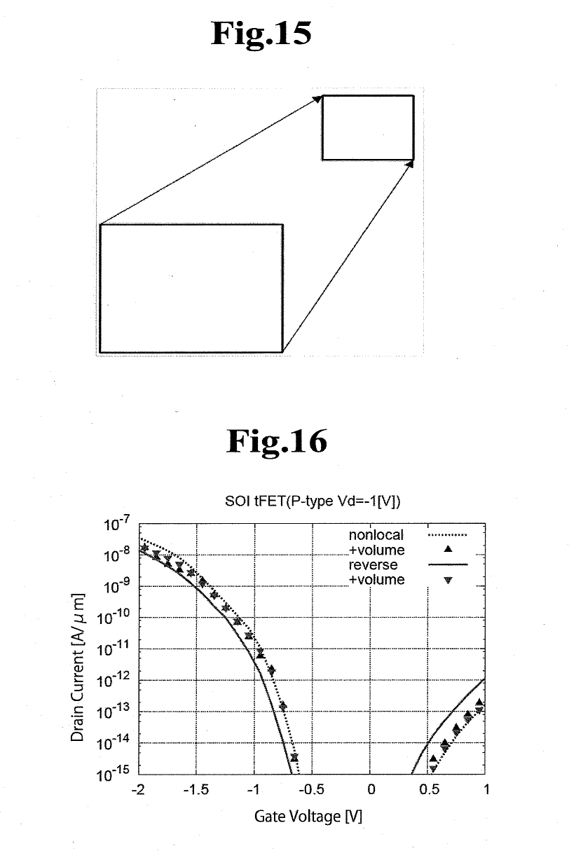

The drain current variations in the option (c) are considered to be caused by a volume effect that occurs due to anisotropy of the tunneling path. As shown in FIG. 15, tunneling may occur in a direction where the volume of the tunnel will decrease or in a direction where the volume of the tunnel will increase, depending on the location where the tunneling occurs. When the tunneling occurs in such a manner as mentioned above, a state density in an effective final state varies. Thus, an amount of tunneling may change, in proportion to the state density. This volume effect is supposed to have an impact on a two-dimensional or a three-dimensional edge portion of a PN junction. A conventional device simulator, however, does not usually take this volume effect into consideration. This volume effect is considered to be particularly significant in a device such as the tunnel FET strongly associated with the MOS interface.

Results of computations with consideration of the volume effect were compared with results of computations before consideration of the volume effect (as shown in FIG. 16). Curves indicated by broken lines show the results when tracing was performed in the forward and backward directions by the method before consideration of the volume effect, and the curves with marks show results when tracing was performed in the forward and backward directions by the method in which the volume effect was taken into consideration. When the volume effect was taken into consideration, the substantially same results were obtained, irrespective of the tracing directions.

### [Compact Model]

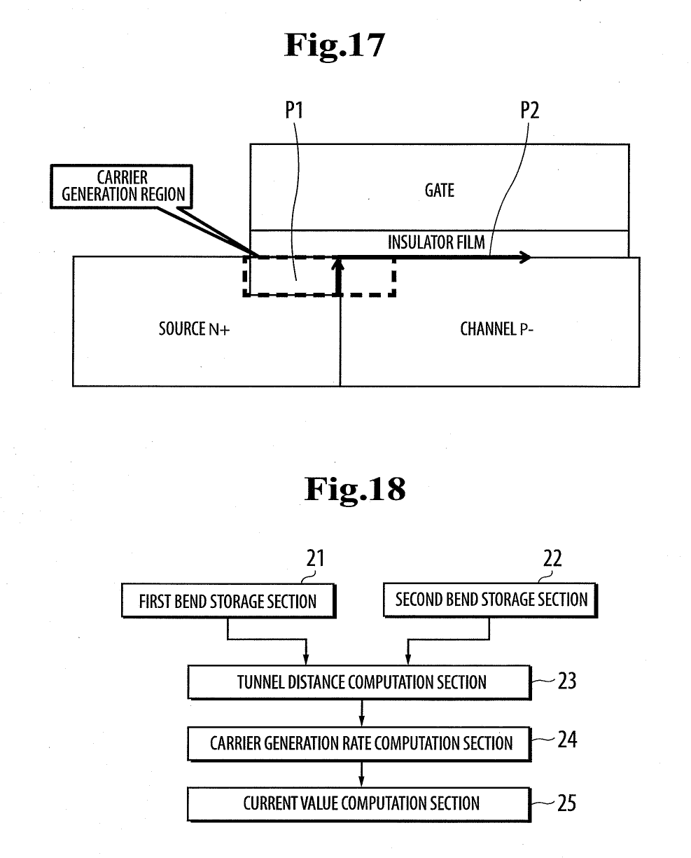

A compact model of nonlocal electric field band-to-band tunneling of a tunnel-FET of the present invention which may be used for a circuit simulator will be described below. As adopted in the device simulation system in the first embodiment of the preset invention, steep band transitions are adopted in the compact model, and nonlocality of a tunnel path is taken into consideration. In order to implement this compact model of nonlocal electrical field band-to-band tunneling using simple computation, the following approximation is introduced into the compact model of the present invention, as shown in FIG. 17. That is, the approximation is introduced where a nonlocal tunnel path is divided into two paths that area vertical path P1 vertical to a source-gate overlap portion and a horizontal path P2 extending from the source-gate overlap portion to a drain in a horizontal direction along a channel interface.

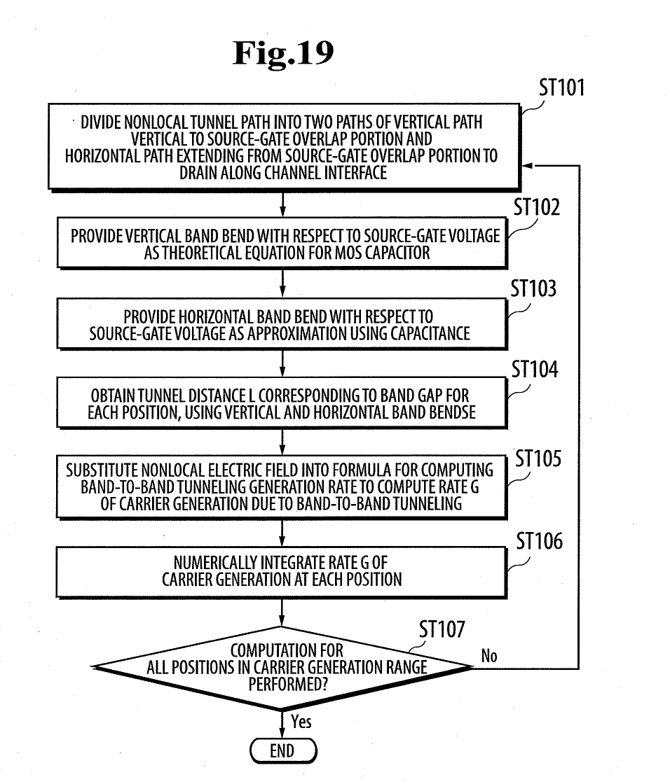

FIG. 18 is a block diagram showing a configuration of an embodiment where the compact model of the present invention and a modeling method for the compact model of the present invention are implemented by a computer. FIG. 19 is a flowchart showing an algorithm of software to be installed into the computer.

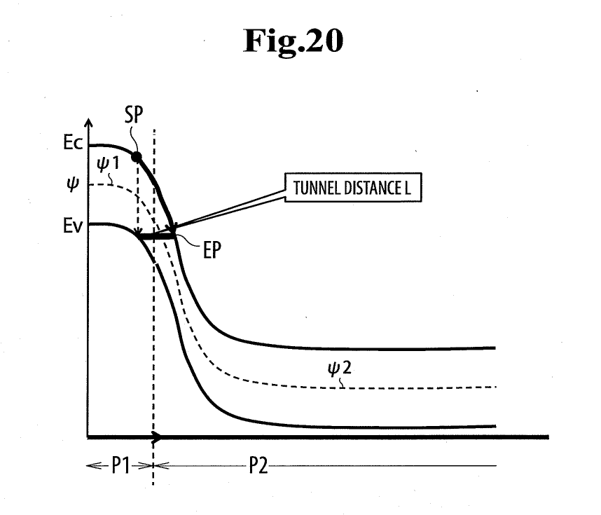

The compact model of nonlocal electric field band-to-band tunneling of the tunnel-FET in this embodiment comprises a first bend storage section (first storage section) 21, a second bend storage section (second storage section) 22, a tunnel distance computation section (third computation section) 23, a carrier generation rate computation section (fourth computation section) 24, and a current value computation section (fifth computation section) 25. The first bend storage section 21 divides the tunnel path of the tunnel-FET at the source-gate overlap portion into the two paths that are the vertical path vertical to the source-gate overlap portion and the horizontal path extending to the drain in the horizontal direction along the channel interface, and stores a bend of a mid-gap potential on the vertical path with respect to a source-gate voltage as an approximation function of the mid-gap potential based on a theoretical equation for a MOS capacitor (in steps ST101 and ST102 in FIG. 19). The function of the bend (first bend) of the mid-gap potential on the vertical path P1 with respect to the source-gate voltage is indicated by Ψ1 in FIG. 20. As an example of an approximation of the mid-gap potential showing the bend Ψ1 of the mid-gap potential in a vertical direction, there is provided Equation (1) disclosed in Known Document 6 (Jin He; Chan, M.; Xing Zhang; Yang yuan Wang, “A Physics-Based Analytic Solution to the MOSFET Surface Potential From Accumulation to Strong-Inversion Region,” Electron Devices, IEEE Transactions on, vol. 53, no. 9, pp. 2008, 2016, September 2006). The approximation of the mid-gap potential is not limited to the one described in this Known Document.

The second bend storage section 22 stores a second bend Ψ2 of the mid-gap potential in the horizontal direction with respect to the source-gate voltage (shown in FIG. 20) as an approximate function of the mid-gap potential using capacitance (in step ST103 in FIG. 19).

As the approximation using capacitance, the following equation, for example, can be employed:

Ψ(x)=[Vₛ·Cₛ(x)+V_{g}·C_{g}]/[Cₛ(x)+V_{g}·C_{g}]

where Vₛ is a source voltage, while V_{g} is a gate voltage.

Further, Cₛ(x)=∈ₛₑₘᵢ/x, ∈ₛₑₘᵢ is the semiconductor permittivity, and x is a distance from the source. Further, C_{g}=∈ₛₑₘᵢ/Tᵢₙₛ, ∈ₛₑₘᵢ is the permittivity of the gate dielectric film, and Tᵢₙₛ is thickness of the gate dielectric film.

The tunnel distance computation section 23 computes a tunnel distance L for each position of a nonlocal electric field band-to-band tunnel, using the first bend Ψ1 and the second bend Ψ2 of a mid-gap potential Ψ (in step ST104 in FIG. 19). Positions of the conduction band Ec and the valence band Ev are determined based on ±½E_{G}+the approximation of the mid-gap Ψ (approximation functions of Ψ1 and Ψ2). Accordingly, by identifying a position EP of the conduction band E_{C} that has the same energy as that of the valence band E_{V} when a start point SP shown in FIG. 20 is set to a start point, the tunnel distance L may be obtained. Accordingly, the tunnel distance computation section 23 obtains the mid-gap potential Ψ using the function of the first bend Ψ1 and the function of the second bend Ψ2, determines the position of the end point (EP) relative to the start point SP, and then computes the tunnel distance L.

The carrier generation rate computation section 24 computes a rate G of carrier generation due to band-to-band tunneling at each position of the nonlocal electric field band-to-band tunnel, based on the tunnel distance L and a band gap E_{G} (in step ST105 in FIG. 19). The band gap E_{G} is obtained from the device simulation system. The carrier generation rate computation section 24 may calculate the rate of carrier generation due to the band-to-band tunneling based on the tunnel distance L and the band gap E_{G}, according to the following equation:

G=A·Enonl^{p}·exp[−L/(E_{G}/B)]

where A, B, and p are parameters of Kane's formula to be determined by a semiconductor material, and Enol is a nonlocal electric field obtained from the device simulation system.

Then, the current value computation section (third computation section) 25 numerically integrates the rate G of carrier generation at each position of a carrier generation range, thereby obtaining a current value (in step ST106 and step ST107 in FIG. 19). Specifically, the rate G of carrier generation at each position is numerically integrated to obtain the total rate of carrier generation along the tunnel path. Then, by multiplying the total rate of carrier generation by an elementary charge q0 and the area of the tunnel path, the current of the tunnel-FET may be obtained. According to the present invention, a compact model may be provided whereby vertical and horizontal band energy distributions may be computed using an electrode voltage and then a distance necessary for tunneling may be obtained.

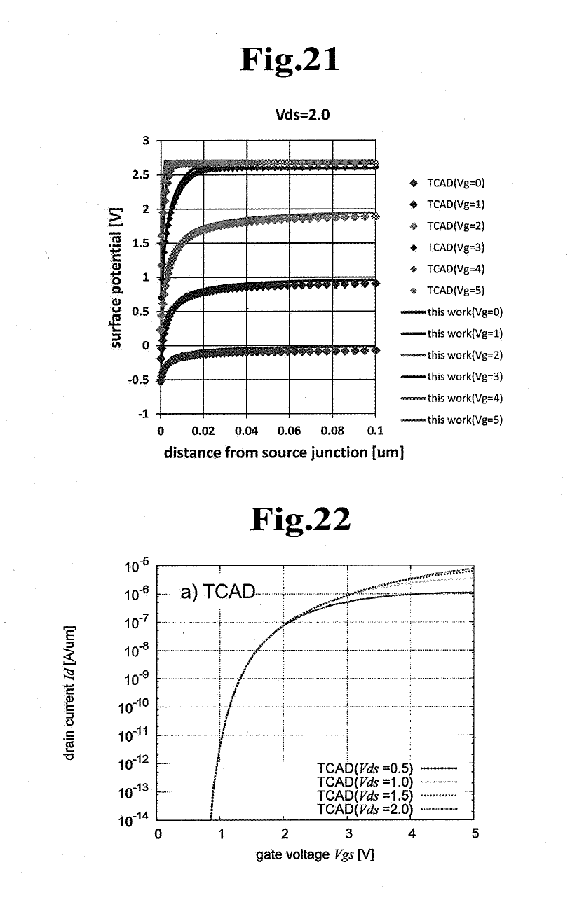

The vertical band exists in a simple MOS structure constituted from the gate, the oxide film, and the source. Thus, the bend of the band with respect to the source-gate voltage may be obtained, using the theoretical equation for a MOS capacitor. The horizontal band may be obtained by assuming that a potential at each point on the interface is divided according to the capacitance ratio between the source and the gate. FIG. 21 shows comparisons of potentials in the lateral direction computed under this assumption with potentials computed by the device simulation system. From FIG. 21, it can be confirmed that the potentials in the lateral direction agree well with the potentials computed by the device simulation system.

The vertical and horizontal band energy distributions may be computed by the compact model in this embodiment using the electrode voltage. The distance necessary for the tunneling may be obtained. That is, the essence of the nonlocal model used in the device simulation system may be incorporated into the compact model due to these assumptions.

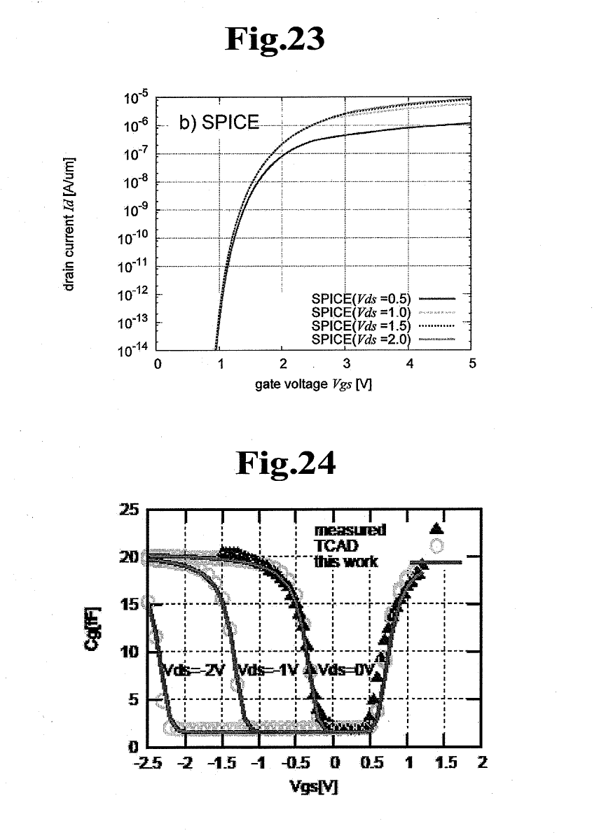

Id-Vg characteristics of an N-type TFET were computed by the compact model in this embodiment, and were compared with those obtained by the TCAD system. FIG. 22 shows the Id-Vgs characteristics of the N-type TFET computed by the device simulation system (device simulator) using the nonlocal model. FIG. 23 shows the Id-Vgs characteristics of the N-type TFET computed by the compact model. It can be seen from these graphs that the results computed by the compact model including drain voltages reproduce the results obtained by the device simulation system very well. It can be seen that the assumptions introduced into the compact model in this embodiment were appropriate.

Since the compact model of this embodiment is a physical model constructed based on physics, model parameters are also constituted from physically significant parameters. Table 1 shows examples of the model parameters. These model parameters indicate that performance of a circuit using TFETs made of various structures and various materials may be predicted in terms of physics.

TABLE 1

| Parameters | Unit | Typical | Explanation |
|---|---|---|---|
| NSOURCE | 1/m³ | 2 × 10³⁶ | Source concentration |
| NSUB | 1/m³ | 1 × 10²⁰ | Channel concentration |
| TOX | M | 10⁻⁹ | Effective oxide thickness |
| OVS | M | 10⁻⁸ | Source gate overlap length |
| SIGMAS | M | 5 × 10⁻⁹ | Lateral sigma of source dopant |

In addition to the modeling performed in this embodiment, effects as shown in Table 2 need to be incorporated in order to cause the compact model to become the one for practical use.

TABLE 2

| Target Characteristics | Theory |
|---|---|
| Source drain asymmetry | Diode currents and Esaki tunneling |
| Off state leakage | Nonlocal BTBT at drain edge |
| Temperature dependence | Temperature dependent Eg, ni, . . |
| Capacitance | Gate to source/drain capacitances |

A capacitance model is essential for performing transient analysis in the above-mentioned embodiment. Thus, a gate capacitance model has been developed, in view of the structure of a tunnel-FET.

When actually measured Cg-Vg characteristics, Cg-Vg characteristics computed by the device simulation system (device simulator), and Cg-Vg characteristics computed by the compact model were compared, it could be confirmed that the results obtained by the compact model including drain voltage dependence agreed well with the results of physical computations by the device simulation system (as shown in FIG. 24). The channel of the tunnel-FET has the same conductivity type as the drain of the tunnel-FET and only the source of the tunnel-FET uses an impurity of the conductivity type different from the conductivity type of the channel and the drain. Thus, a gate-drain capacitance is dominant as the capacitance of the tunnel-FET.

The above-mentioned physical model was described in Verilog-A language. Then, a result of analysis of operation of an inverter using N-type and P-type TFETs by a commercially available SPICE circuit simulator is shown in FIG. 25, as an example of simple circuit analysis. Since a small tunneling current is obtained for physical parameters for silicon, driving current is insufficient with respect to the capacitance. Overshoot of an output voltage waveform was observed at a nanosecond level. A normal waveform was obtained at a microsecond level. When such circuit performance can be predicted, an application of the tunnel-FET may be studied or an effect of use of a new material such as a germanium channel may be studied before tunnel-FET development.

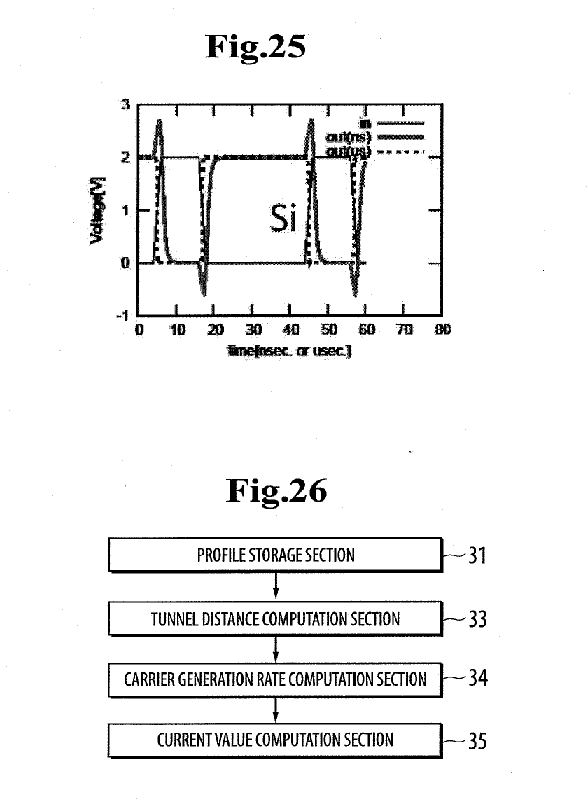

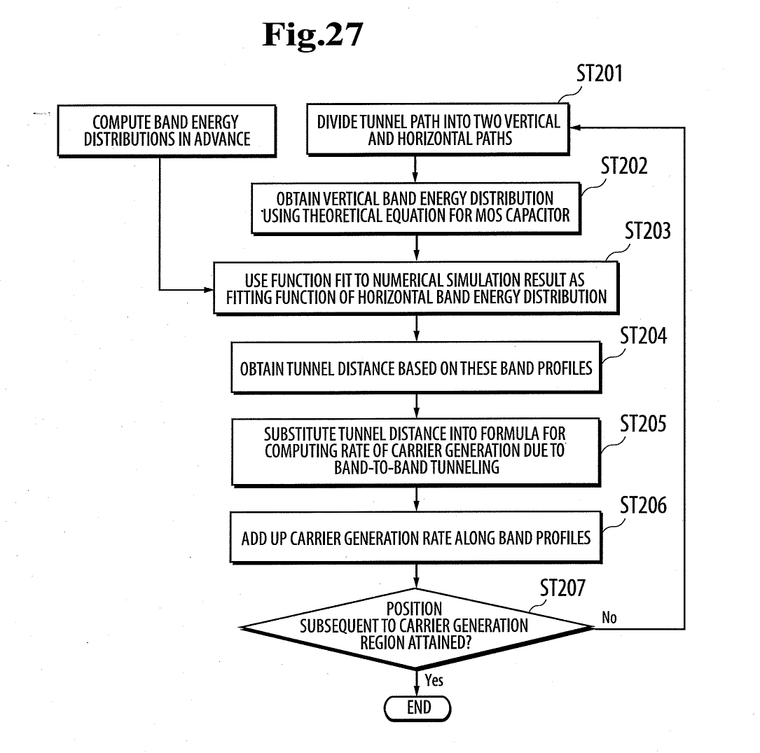

FIG. 26 is a block diagram showing a configuration of a compact model in a different embodiment of the present invention. FIG. 27 is a flowchart of software to be used when this embodiment is implemented by a computer. This compact model includes a profile storage section 31 and first to third computation sections 33 to 35. The profile storage section 31 is provided. Thus, the tunnel path of a tunnel TFET at a source-gate overlap portion is divided into two paths that are a vertical path vertical to the source-gate overlap portion and a horizontal path extending to a drain in a horizontal direction along a channel interface, and a vertical energy distribution of a mid-gap potential on the vertical path with respect to a source-gate voltage is obtained as an approximation function of the mid-gap potential based on a theoretical equation for a MOS capacitor (in step ST202). Then, as a fitting function of a horizontal energy distribution of the mid-gap potential on the horizontal path with respect to the source-gate voltage, a function fit to a numerical simulation result is used. For that purpose, the band energy distributions are computed by numerical simulation in advance. Then, the vertical band energy distribution is stored in the profile storage section 31 as the function (band profile) of the theoretical equation for a MOS capacitor, and the fitting function of the horizontal band energy distribution is stored in the profile storage section 31 as the function (band profile) fit to the numerical simulation result.

The tunnel distance computation section 33 computes a tunnel distance L for each position of a nonlocal electric field band-to-band tunnel, using the band profiles stored in the profile storage section 31 (in step ST206). Then, the carrier generation rate computation section 34 computes a rate G of carrier generation due to band-to-band tunneling, based on the computed tunnel distance L and a band gap E_{G} obtained from the device simulation system (in step ST205). The computing equation of the rate G of carrier generation is the same as that used in the embodiment described first. Then, the current value computation section 35 obtains a current value by numerically integrating (adding up) the rate of carrier generation at each position in the range of the carrier generation along the band profiles (in steps ST206 and ST207 in FIG. 27). According to the compact model in this embodiment, by using the profile storage section 31, a compact model with a higher accuracy may be provided.

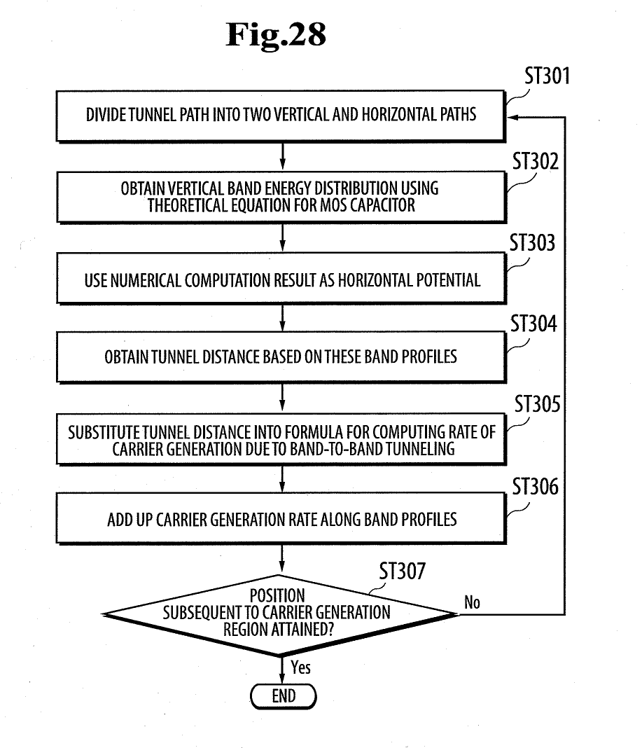

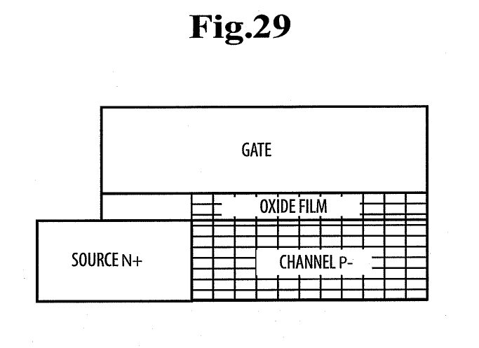

FIG. 28 is a flowchart showing an algorithm of software to be used in an embodiment for obtaining band profiles to be stored in the profile storage section 31 by a method different from the one shown in FIG. 27. This algorithm is the same as the algorithm shown in FIG. 27 except step ST303 corresponding to ST203 in the algorithm shown in FIG. 27. Then, by adding 100 to reference signs shown in the flowchart in FIG. 27, description of the algorithm in FIG. 28 will be omitted. In this embodiment, a numerical computation result is used, as a horizontal band energy distribution (potential) indicating a horizontal mid-gap potential with respect to a source-gate voltage. FIG. 29 is a diagram for explaining a concept when the horizontal band energy distribution (potential) is used by numerical computation. That is, the oxide film or insulator film and the channel are divided into meshes. Then, by solving the Laplace's equation [∇(∈∇Ψ)=0] using the numerical computation and using a potential between the source and the gate as a boundary condition, a gap potential from the source may be obtained. The other steps ST301, ST302, ST304, ST305 to ST307 are the same as steps ST201, ST202, ST204, and ST205 to ST207 in FIG. 27.

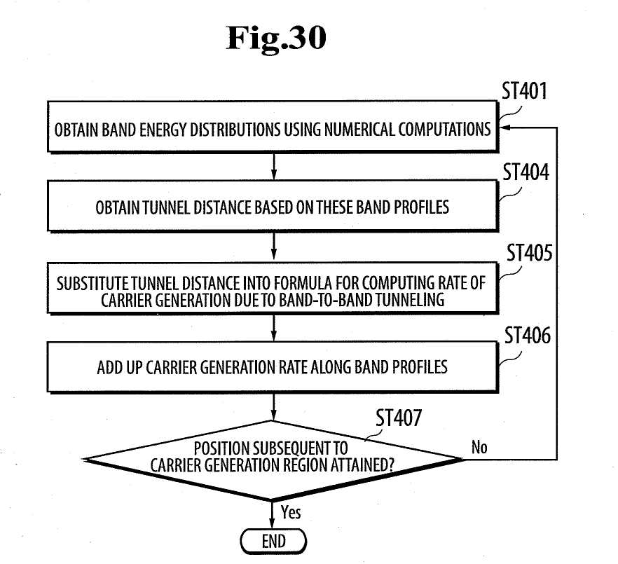

Naturally, it may be so arranged that band energy distributions are obtained by numerical computation and are then stored in the profile storage section 31 as band profiles (in step ST401), as in an algorithm shown in FIG. 30. Steps ST404 to ST407 in the algorithm in FIG. 30 are the same as steps ST204 to ST207 in the algorithm in FIG. 27.

According to the present invention, even if a tunnel path is steeply bent as in a tunnel-FET, simulation of the tunnel-FET may be performed with a high accuracy. Further, according to the compact model of the present invention, by adopting the nonlocal model for the compact model, consistent development from elements of the tunnel-FET to a circuit to be implemented by the tunnel-FET has become possible.

While certain features of the invention have been described with reference to example embodiments, the description is not intended to be construed in a limiting sense. Various modifications of the example embodiments, as well as other embodiments of the invention, which are apparent to persons skilled in the art to which the invention pertains, are deemed to lie within the spirit and scope of the invention.

1. A device simulation method of simulating a rate of carrier generation due to band-to-band tunneling in a tunnel-FET, comprising the steps of:
tracing band energy of the tunnel-FET to obtain a tunnel distance L;
defining a nonlocal electric field Enonl (=E_{G}/L) using a band gap E_{G} and the tunnel distance L obtained by the step of tracing the band energy of the tunnel-FET; and
computing a rate G of carrier generation due to band-to-band tunneling, based on the following equation:
G=A·Enonl^{p}·exp(−B/Enonl)
where A, B, and p are parameters of Kane's formula to be determined by a semiconductor material.

2. A device simulation method of simulating a rate of carrier generation due to band-to-band tunneling in a tunnel-FET by using a device simulator, comprising the steps of:
tracing band energy of the tunnel-FET to obtain a tunnel distance L;
defining a nonlocal electric field Enonl (=E_{G}/L) using a band gap E_{G} and the tunnel distance L obtained by the step of tracing the band energy of the tunnel-FET; and
computing a rate G of carrier generation due to band-to-band tunneling, based the nonlocal electric field Enonl, the tunnel distance L, and the band gap E_{G}, according to the following equation:
G=A·Enon^{p}·exp[−L/(E_{G}/B)]
where A, B, and p are parameters of Kane's formula to be determined by a semiconductor material.

3. The device simulation method according to claim 1, wherein the band energy is energy of one of a conduction band E_{C} and a valance band E_{V}.

4. The device simulation method according to claim 2, wherein
the band energy is energy of one of a conduction band E_{C} and a valance band E_{V}.

5. The device simulation method according to claim 3, wherein
the step of tracing the band energy of the tunnel-FET includes:
a step of assuming a plurality of meshes including a plurality of mesh points and dividing an analysis target structure into the plurality of meshes including the plurality of mesh points;
a first selection step of setting one of the plurality of mesh points of the plurality of meshes as a start point and then selecting, from among the mesh points around the start point, the mesh point with a largest energy gradient;
a second selection step of setting the selected mesh point as a start point and then selecting, from among the mesh points around the selected mesh point as the start point, the mesh point with a largest energy gradient;
a step of repeating the second selection step until the mesh point with energy that is the same as energy of the other of the conduction band and the valence band is obtained as an end point; and
a step of determining, as the tunnel distance, a distance obtained by adding up distances between two adjacent ones of the mesh point of the start point, the selected mesh points, and the mesh point of the end point.

6. The device simulation method according to claim 4, wherein
the step of tracing the band energy of the tunnel-FET includes:
a step of assuming a plurality of meshes including a plurality of mesh points and dividing an analysis target structure into the plurality of meshes including the plurality of mesh points;
a first selection step of setting one of the plurality of mesh points of the plurality of meshes as a start point and then selecting, from among the mesh points around the start point, the mesh point with a largest energy gradient;
a second selection step of setting the selected mesh point as a start point and then selecting, from among the mesh points around the selected mesh point as the start point, the mesh point with a largest energy gradient;
a step of repeating the second selection step until the mesh point with energy that is the same as energy of the other of the conduction band and the valence band is obtained as an end point; and
a step of determining, as the tunnel distance, a distance obtained by adding up distances between two adjacent ones of the mesh point of the start point, the selected mesh points, and the mesh point of the end point.

7. The device simulation method according to claim 3, wherein
the step of tracing the band energy of the tunnel-FET includes:
a step of assuming a plurality of meshes including a plurality of mesh points, for one of the conduction band and the valence band;
a first selection step of setting one of the plurality of mesh points of the plurality of meshes as a start point and then selecting, from among the mesh points around the start point, the mesh point with a largest energy gradient;
a second selection step of setting the selected mesh point as a start point and then selecting, from among the mesh points around the selected mesh point as the start point, the mesh point with a largest energy gradient;
a step of repeating the second selection step until the mesh point with energy that is the same as energy of the other of the conduction band and the valence band is obtained as an end point; and
a step of determining, as the tunnel distance, a distance between the mesh point of the start point and the mesh point of the end point.

8. The device simulation method according to claim 4, wherein
the step of tracing the band energy of the tunnel-FET includes:
a step of assuming a plurality of meshes including a plurality of mesh points, for one of the conduction band and the valence band;
a first selection step of setting one of the plurality of mesh points of the plurality of meshes as a start point and then selecting, from among the mesh points around the start point, the mesh point with a largest energy gradient;
a second selection step of setting the selected mesh point as a start point and then selecting, from among the mesh points around the selected mesh point as the start point, the mesh point with a largest energy gradient;
a step of repeating the second selection step until the mesh point with energy that is the same as energy of the other of the conduction band and the valence band is obtained as an end point; and
a step of determining, as the tunnel distance, a distance between the mesh point of the start point and the mesh point of the end point.

9. The device simulation method according to claim 5, wherein
in the step of tracing the band energy of the tunnel-FET, an energy difference between the conduction band and the valence band at the start point is determined as the band gap E_{G}.

10. The device simulation method according to claim 6, wherein
in the step of tracing the band energy of the tunnel-FET, an energy difference between the conduction band and the valence band at the start point is determined as the band gap E_{G}.

11. A tunnel-FET modeling method, wherein
the tunnel-FET is modeled by obtaining the rate of carrier generation for each of the plurality of mesh points in the plurality of meshes, using the device simulation method according to claim 5.

12. A device simulation system operable to simulate a rate of carrier generation due to band-to-band tunneling in a tunnel-FET, the system comprising:
a tracing section operable to trace band energy of the tunnel-FET to obtain a tunnel distance L and a band gap E_{G};
a nonlocal electric field definition section operable to define a nonlocal electric field Enonl (=E_{G}/L) using the tunnel distance L and the band gap E_{G} obtained by the tracing section; and
a carrier generation rate computation section operable to compute a rate of carrier generation due to band-to-band tunneling, based on the following equation:
G=A·Enonl^{p}·exp(−B/Enonl)
where A, B, and p are parameters of Kane's formula to be determined by a semiconductor material.

13. A device simulation system operable to simulate a rate of carrier generation due to band-to-band tunneling in a tunnel-FET, using a device simulator, the system comprising:
a tracing section operable to trace band energy of the tunnel-FET to obtain a tunnel distance L and a band gap E_{G};
a nonlocal electric field defining section operable to define a nonlocal electric field Enonl (=E_{G}/L) using the tunnel distance L and the band gap E_{G} obtained by the tracing section; and
a carrier generation rate computing section operable to compute a rate of carrier generation due to band-to-band tunneling, based the nonlocal electric field Enonl, the tunnel distance L, and the band gap E_{G}, according to the following equation:
G=A·Enonl^{p}·exp[−L/(E_{G}/B)]
where A, B, and p are parameters of Kane's formula to be determined by a semiconductor material.

14. The device simulation system according to claim 12, wherein
the band energy is energy of one of a conduction band E_{C} and a valance band E_{V}.

15. The device simulation system according to claim 13, wherein
the band energy is energy of one of a conduction band E_{C} and a valance band E_{V}.

16. The device simulation system according to claim 14, wherein the tracing section includes:
a mesh assumption section operable to assume a plurality of meshes including a plurality of mesh points and divide an analysis target structure into the plurality of meshes including the plurality of mesh points;
a first selection section operable to set one of the plurality of mesh points of the plurality of meshes as a start point and then to perform a first selection step of selecting, from among the mesh points around the start point, the mesh point with a largest energy gradient;
a second selection section operable to set the selected mesh point as a start point and then to perform a second selection step of selecting, from among the mesh points around the selected mesh point as the start point, the mesh point with a largest energy gradient;
a repetition section operable to repeat the second selection step until the mesh point with energy that is the same as energy of the other of the conduction band and the valence band is obtained as an end point; and
a tunnel distance determination section operable to determine, as the tunnel distance, a distance obtained by adding up distances between two adjacent ones of the mesh point of the start point, the selected mesh points, and the mesh point of the end point.

17. The device simulation system according to claim 15, wherein
the tracing section includes:
a mesh assumption section operable to assume a plurality of meshes including a plurality of mesh points and divide an analysis target structure into the plurality of meshes including the plurality of mesh points;
a first selection section operable to set one of the plurality of mesh points of the plurality of meshes as a start point and then to perform a first selection step of selecting, from among the mesh points around the start point, the mesh point with a largest energy gradient;
a second selection section operable to set the selected mesh point as a start point and then to perform a second selection step of selecting, from among the mesh points around the selected mesh point as the start point, the mesh point with a largest energy gradient;
a repetition section operable to repeat the second selection step until the mesh point with energy that is the same as energy of the other of the conduction band and the valence band is obtained as an end point; and
a tunnel distance determination section operable to determine, as the tunnel distance, a distance obtained by adding up distances between two adjacent ones of the mesh point of the start point, the selected mesh points, and the mesh point of the end point.

18. The device simulation system according to claim 14, wherein
the tracing section includes:
a mesh assumption section operable to assume a plurality of meshes including a plurality of mesh points, for one of the conduction band and the valence band;
a first selection section operable to set one of the plurality of mesh points of the plurality of meshes as a start point and then to perform a first step of selecting, from among the mesh points around the start point, the mesh point with a largest energy gradient;
a second selection section operable to set the selected mesh point as a start point and then to perform a second step of selecting, from among the mesh points around the selected mesh point as the start point, the mesh point with a largest energy gradient;
a repetition section operable to repeat the second selection step until the mesh point with energy that is the same as energy of the other of the conduction band and the valence band is obtained as an end point; and
a tunnel distance determination section operable to determine, as the tunnel distance, a distance between the mesh point of the start point and the mesh point of the end point.

19. The device simulation system according to claim 15, wherein
the tracing section includes:
a mesh assumption section operable to assume a plurality of meshes including a plurality of mesh points, for one of the conduction band and the valence band;
a first selection section operable to set one of the plurality of mesh points of the plurality of meshes as a start point and then to perform a first step of selecting, from among the mesh points around the start point, the mesh point with a largest energy gradient;
a second selection section operable to set the selected mesh point as a start point and then to perform a second step of selecting, from among the mesh points around the selected mesh point as the start point, the mesh point with a largest energy gradient;
a repetition section operable to repeat the second selection step until the mesh point with energy that is the same as energy of the other of the conduction band and the valence band is obtained as an end point; and
a tunnel distance determination section operable to determine, as the tunnel distance, a distance between the mesh point of the start point and the mesh point of the end point.

20. The device simulation system according to claim 16, wherein
the tracing section determines an energy difference between the conduction band and the valence band at the start point, as the band gap E_{G}.

21. The device simulation system according to claim 17, wherein
the tracing section determines an energy difference between the conduction band and the valence band at the start point, as the band gap E_{G}.

22. The device simulation system according to claim 18, wherein
the tracing section determines an energy difference between the conduction band and the valence band at the start point, as the band gap E_{G}.

23. The device simulation system according to claim 19, wherein
the tracing section determines an energy difference between the conduction band and the valence band at the start point, as the band gap E_{G}.

24. A tunnel-FET modeling system, wherein
the tunnel-FET is modeled by obtaining the carrier generation rate for each of the plurality of mesh points in the plurality of meshes, using the device simulation system according to claim 16.

25. A modeling method for a compact model of nonlocal band-to-band tunneling of a tunnel-FET, the method comprising:
a first step of dividing a tunnel path of the tunnel-FET at a source-gate overlap portion into two paths that are a vertical path vertical to the source-gate overlap portion and a horizontal path extending to a drain in a horizontal direction along a channel interface, and storing a first bend of a mid-gap potential on the vertical path with respect to a source-gate voltage as an approximation function of the mid-gap potential based on a theoretical equation for a MOS capacitor;
a second step of storing a second bend of the mid-gap potential on the horizontal path with respect to the source-gate voltage as an approximation function of the mid-gap potential using capacitance;
a third step of obtaining a tunnel distance L for each position of a nonlocal electric field band-to-band tunnel, using the first and second bends;
a fourth step of computing a rate G of carrier generation due to band-to-band tunneling at each position of the nonlocal electric field band-to-band tunnel, based on the tunnel distance L and a band gap E_{G}; and
a fifth step of obtaining a current value by numerically integrating the rate of carrier generation at each position of the nonlocal electric field band-to-band tunnel;
wherein the compact model of nonlocal band-to-band tunneling of the tunnel-FET is so designed that the current value obtained in the fifth step is equal to a value of an output current with respect to the source-to-gate voltage.

26. The modeling method for a compact model of nonlocal band-to-band tunneling of a tunnel FET according to claim 25, wherein
in the fourth step, based on the tunnel distance L and the band gap E_{G}, the rate of carrier generation due to the band-to-band tunneling is computed by the following equation:
G=A·Enonl^{p}·exp[−L/(E_{G}/B)]
where A, B, and p are parameters of Kane's formula to be determined by a semiconductor material, and Enonl^{p} is a nonlocal electric field.

27. A compact model of nonlocal band-to-band tunneling of a tunnel-FET, comprising:
a first storage section operable to divide a tunnel path of the tunnel-FET at a source-gate overlap portion into two paths that are a vertical path vertical to the source-gate overlap portion and a horizontal path extending to a drain in a horizontal direction along a channel interface, and to store a first bend of a mid-gap potential on the vertical path with respect to a source-gate voltage as an approximation function of the mid-gap potential based on a theoretical equation for a MOS capacitor;
a second storage section operable to store a second bend of the mid-gap potential on the horizontal path with respect to the source-gate voltage as an approximation function of the mid-gap potential using capacitance;
a first computation section operable to obtain a tunnel distance L for each position of a nonlocal electric field band-to-band tunnel, using the first and second bends of the mid-gap potential;
a second computation section operable to compute a rate G of carrier generation due to band-to-band tunneling at each position of the nonlocal electric field band-to-band tunnel, based on the tunnel distance L and a band gap E_{G}; and
a third computation section operable to obtain a current value by numerically integrating the carrier generation rate at each position of the nonlocal electric field band-to-band tunnel.

28. The compact model according to claim 27, wherein
based on the tunnel distance L and the band gap E_{G}, the second computation section computes the rate of carrier generation due to the band-to-band tunneling by the following equation:
G=A·Enonl^{p}·exp[−L/(E_{G}/B)]
where A, B, and p are parameters of Kane's formula to be determined by a semiconductor material, and Enol^{p} is a nonlocal electric field.

29. A compact model of nonlocal band-to-band tunneling of a tunnel-FET, comprising:
a profile storage section operable to divide a tunnel path of the tunnel-FET at a source-gate overlap portion into two paths that are a vertical path vertical to the source-gate overlap portion and a horizontal path extending to a drain in a horizontal direction along a channel interface, to store a vertical energy distribution of a mid-gap potential on the vertical path with respect to a source-gate voltage as an approximation function of the mid-gap potential based on a theoretical equation for a MOS capacitor, and to store a fitting function of a horizontal energy distribution of the mid-gap potential on the horizontal path with respect to the source-gate voltage as a function fit to a numerical simulation result, thereby storing a profile of the mid-gap potential of a nonlocal electric field band-to-band tunnel;
a first computation section operable to obtain a tunnel distance L for each position of the nonlocal electric field band-to-band tunnel, using the profile;
a second computation section operable to compute a rate G of carrier generation due to band-to-band tunneling based on the tunnel distance L and a band gap E_{G}; and
a third computation section operable to obtain a current value by numerically integrating the rate of carrier generation at each position of the nonlocal electric field band-to-band tunnel.

30. The compact model according to claim 29, wherein
based on the tunnel distance L and the band gap E_{G}, the second computation section computes the rate of carrier generation due to the band-to-band tunneling by the following equation:
G=A·Enonl^{p}·exp[−L/(E_{G}/B)]
where A, B, and p are parameters of Kane's formula to be determined by a semiconductor material, and Enol^{p} is a nonlocal electric field.

31. A compact model of nonlocal band-to-band tunneling of a tunnel-FET, comprising:
a profile storage section operable to divide a tunnel path of the tunnel-FET at a source-gate overlap portion into two paths that are a vertical path vertical to the source-gate overlap portion and a horizontal path extending to a drain in a horizontal direction along a channel interface, to store a mid-gap potential on the vertical path with respect to a source-gate voltage calculated by an approximation of the mid-gap potential based on a theoretical equation for a MOS capacitor, and to store the mid-gap potential on the horizontal path with respect to the source-gate voltage determined based on a numerical simulation result, thereby storing a profile of the mid-gap potential of a nonlocal electric field band-to-band tunnel;
a first computation section operable to obtain a tunnel distance L for each position of the nonlocal electric field band-to-band tunnel, using the profile;
a second computation section operable to compute a rate G of carrier generation due to band-to-band tunneling based on the tunnel distance L and a band gap E_{G}; and
a third computation section operable to obtain a current value by numerically integrating the rate of carrier generation at each position of the tunnel.

32. The compact model according to claim 31, wherein
based on the tunnel distance L and the band gap E_{G}, the second computation section computes the rate of carrier generation due to the band-to-band tunneling by the following equation:
G=A·Enonl^{p}·exp[−L/(E_{G}/B)]
where A, B, and p are parameters of Kane's formula to be determined by a semiconductor material, and Enol^{p} is a nonlocal electric field.
